(19) United States
(12) Patent Application Publication
(10) Pub. No.: US 2010/0075151 A1
(43) Pub. Date: Mar. 25, 2010

(54) METHOD FOR CONTROLLING AND LIMITING ADHESIVE MIGRATION USING ANTI WETTING AGENT

(75) Inventors: Jerry Weingord, Scotts Valley, CA (US); Thaveesinn Vasavakul, Scotts Valley, CA (US)

Correspondence Address: SEAGATE TECHNOLOGY LLC;C/O NOVAK DRUCE & QUIGG LLP, 1000 LOUISIANA, Fifty-Third Floor, HOUSTON, TX, 77002, US

(73) Assignee: Seagate Technology LLC, Scotts Valley, CA (US)

(21) Appl. No.: 12/234,494

(22) Filed: Sep. 19, 2008

(51) Int. Cl. B32B 17/06; B32B 37/12; B32B 15/00; B32B 15/04; B32B 15/08; B32B 18/00; B32B 27/06; B32B 17/10; B32B 15/082; B32B 15/20; B32B 17/00

(52) U.S. Cl. 428/421; 156/314; 156/315; 428/428; 428/433; 428/441; 428/461; 428/457; 428/426; 428/523; 428/688; 428/446; 428/451

(57) ABSTRACT

A method and assembly for controlling adhesive migration is provided. The method uses a surface altering agent that can limit the flow of adhesive. The surface altering agent may prevent the wetting of the surface area to which it is applied. As two components are coupled together, the adhesive may spread beyond their boarders. The surface altering agent may prevent the spread of the adhesive into sensitive areas.

### BACKGROUND

1. Field of the Invention

The invention is directed to adhesion and, in particular, methods and tools for controlling adhesion migration in an assembly with an anti-wetting agent.

2. Background of the Invention

All liquids will spread out, or “wet,” any surface where the surface energy is higher than the surface tension of the fluid. For instance, due to the very high surface energies of metals, fluids normally spread on any truly clean metal surface. This spread may be caused by gravity or forced through pressure. By modifying the surface of the metal or other solid, it is possible to retard or even prevent the migration of fluids on that surface.

To prevent the spread of oils and other environmental liquids, an anti-wetting agent, also known as a barrier film, is often employed in printed circuitry. A very thin layer of the film, which has a very low surface energy, can control wetting by changing the surface characteristics of surfaces by, for example, filling capillaries. Such barrier films are often used not only to control oil creep, but also, to protect circuit boards by repelling moisture and attendant dust entrapment.

In constructing devices it is often necessary to couple two objects together. One such method of coupling is through the use of an adhesive. An adhesive is a compound that adheres or bonds two items together. Adhesives may come from either natural or synthetic sources. Some modern adhesives are extremely strong.

Often, such as when two or more parts are coupled together with an adhesive, the adhesive seeps beyond the confines of the objects and may flow unpredictably towards critical components or areas before the adhesive cures. This may result in contamination to parts and consequently product reliability risk.

One method used to prevent the spread of adhesive is to create a groove in one of the parts that traps the adhesive and prevents it from continuing to flow. However, this groove may become filled before all the adhesive is trapped, thereby allowing the adhesive to continue to spread. Furthermore, creating this grove is a costly and often difficult, extra step in the construction process. Finally, after the adhesion process is complete, it is usually necessary to subject the assembly to a cleaning process to remove any extra adhesive that has built up during the assembly process.

Another method to overcome the adhesive spread issue disclosed in U.S. Pat. No. 6,251,496 to Papathomas et al. Papathomas et al. coat the entire surface of a substrate that is to be bonded with a substantially non-wettable fluorosilane composition. A solvent may then be applied to the location of adhesion so that the substrate can be bonded to another object.

However, with this method, the entire component is coated with the non-wettable substance. By coating the entire component, an outgassing problem may arise. Outgassing is the slow release of a gas that was trapped, frozen, or adsorbed in some material. Since the entire component is coated, there is more of a chance that trapped gasses will escape and degrade the components in the assembly. Furthermore, in some uses, especially those that entail a considerable amount of motion, portions of the excess non-wettable substance may flake off and cause damage to the assembly.

Therefore it is desirable to have a method of preventing the spread of adhesive without cutting grooves into at least one of the parts to be coupled and without coating an entire component of the assembly.

### SUMMARY OF THE INVENTION

The present invention overcomes the problems and disadvantages associated with current strategies and designs and provides new tools and methods of controlling adhesive migration and, in particular, migration in an assembly.

One embodiment of the invention is directed to methods of applying adhesive to one or more surfaces of one component, applying a surface altering agent to one or more surfaces of one or more components, and coupling two components together.

Another embodiment of the invention is directed to a method where a surface altering agent fills capillaries of the surface area to which it is applied.

Another embodiment of the invention is directed to a method where a surface altering agent prevents wetting of the surface area to which it is applied.

Another embodiment of the invention is directed to a method where a surface altering agent prevents the spread of the adhesive beyond the surface area to which it is applied.

Another embodiment of the invention is directed to a method where a surface altering agent and an adhesive are both applied to the same surface of the first component.

Another embodiment of the invention is directed to a method where a surface altering agent is applied to a location other than the location to which an adhesive is applied.

Another embodiment of the invention is directed to a method where a surface altering agent is applied by dipping the component into the agent.

Another embodiment of the invention is directed to a method where a surface altering agent is applied by spraying the component with the agent.

Another embodiment of the invention is directed to a method where a surface altering agent is applied by painting the component with the agent.

Another embodiment of the invention is directed to a method where a surface altering agent is allowed to dry at room temperature before coupling the components.

Another embodiment of the invention is directed to a method where a surface altering agent is heated to a temperature of grater than 25° C. before coupling the components.

Another embodiment of the invention is directed to a method where the surface altering agent is heated for at least thirty minutes.

Another embodiment of the invention is directed to a method where a surface altering agent is a stable fluorocarbon polymer.

Another embodiment of the invention is directed to a method where a surface altering agent is supplied in perfluoralkane solvents.

Another embodiment of the invention is directed to a method where a perfluoralkane solvent evaporates.

Another embodiment of the invention is directed to a method where a surface altering agent comprises at least one of fluorochemical acrylate polymer substance, a hydrofluoroether solvent, polyethylene, polytetrafluoroethylne, polyvinylidene chloride, polyvinylidene fluoride, ethylene-vinyl alcohol copolymer, metals, aluminum, silicon oxide, silicon dioxide, ethylene, chlorotrifluoroethylene copolymer, and polychlorotrifluoroethylene polymer.

Another embodiment of the invention is directed to a method where a surface altering agent is insoluble in heptane, toluene, water, or combinations thereof.

Another embodiment of the invention is directed to a method where a surface altering agent is strippable with fluorinated solvents.

Another embodiment of the invention is directed to a method where a surface altering agent is transparent.

Another embodiment of the invention is directed to a method where a surface altering agent has a refractive index of 1.5 or less.

Another embodiment of the invention is directed to a method where a surface altering agent has minimal or low toxicity.

Another embodiment of the invention is directed to a method where a surface altering agent has a soft modulus of elasticity.

Another embodiment of the invention is directed to a method where a surface altering agent has a surface energy of less than 35 dynes/cm.

Another embodiment of the invention is directed to a method where a surface altering agent has a surface energy of 12 dynes/cm or less.

Another embodiment of the invention is directed to a method where a surface altering agent has a surface energy of 11 dynes/cm or less.

Another embodiment of the invention is directed to a method where a surface altering agent has a thickness of less than 0.2 microns.

Another embodiment of the invention is directed to a method where a surface altering agent has a thickness of less than 0.1 micron.

Another embodiment of the invention is directed to a method where at least one of the components is metal.

Another embodiment of the invention is directed to a method where at least one of the components are chosen from copper, aluminum, ceramic, steel, tin, glass, and combinations thereof.

Another embodiment of the invention is directed to a method where an adhesive is a two part epoxy.

Another embodiment of the invention is directed to a method where the two parts of an epoxy are mixed on one component.

Another embodiment of the invention is directed to a method where a first part of an epoxy is applied to the first component and a second part of the epoxy is applied to the second component.

Another embodiment of the invention is directed to a method where heat is applied to cure an adhesive.

Another embodiment of the invention is directed to a method where an adhesive is applied using at least one of brushing, dripping, pouring and mechanical dispensing.

Another embodiment of the invention is directed to a method where the surface altering agent is applied to a portion of one surface of one component.

Another embodiment of the invention is directed to a method where at least a part of one surface of one component is free from any surface altering agent.

Another embodiment of the invention is directed to an assembly. The assembly includes, at least two components, an adhesive coupling the first component to the second component, and a surface altering agent to prevent the spread of the adhesive.

Another embodiment of the invention is directed to an assembly where a surface altering agent fills capillaries of the surface area to which it is applied.

Another embodiment of the invention is directed to an assembly where a surface altering agent prevents wetting of the surface area to which it is applied.

Another embodiment of the invention is directed to an assembly where a surface altering agent prevents the spread of the adhesive beyond the surface area to which it is applied.

Another embodiment of the invention is directed to an assembly where a surface altering agent and the adhesive are both applied to the same surface of the first component.

Another embodiment of the invention is directed to an assembly where a surface altering agent is applied to a location other than the location to which the adhesive is applied.

Another embodiment of the invention is directed to an assembly where a surface altering agent is applied by dipping the component into the agent.

Another embodiment of the invention is directed to an assembly where a surface altering agent is applied by spraying the component with the agent.

Another embodiment of the invention is directed to an assembly where a surface altering agent is applied by painting the component with the agent.

Another embodiment of the invention is directed to an assembly where a surface altering agent is dried at room temperature before the components are coupled.

Another embodiment of the invention is directed to an assembly where a surface altering agent is heated to a temperature of grater than 25° C. before the components are coupled.

Another embodiment of the invention is directed to an assembly where a surface altering agent is heated for at least thirty minutes.

Another embodiment of the invention is directed to an assembly where a surface altering agent is a stable fluorocarbon polymer.

Another embodiment of the invention is directed to an assembly where a surface altering agent is supplied in perfluoralkane solvents.

Another embodiment of the invention is directed to an assembly where a perfluoralkane solvent evaporates.

Another embodiment of the invention is directed to an assembly where a surface altering agent is comprised of at least one of fluorocarbon, fluorochemical acrylate polymer substance, a hydrofluoroether solvent, polyethylene, polytetrafluoroethylne, polyvinylidene chloride, polyvinylidene fluoride, ethylene-vinyl alcohol copolymer, metals, aluminum, silicon oxide, silicon dioxide, ethylene, chlorotrifluoroethylene copolymer, and polychlorotrifluoroethylene polymer.

Another embodiment of the invention is directed to an assembly where a surface altering agent is insoluble in heptane, toluene, water, or combinations thereof.

Another embodiment of the invention is directed to an assembly where a surface altering agent is strippable with fluorinated solvents.

Another embodiment of the invention is directed to an assembly where a surface altering agent is transparent.

Another embodiment of the invention is directed to an assembly where a surface altering agent has a refractive index of 1.5 or less.

Another embodiment of the invention is directed to an assembly where a surface altering agent has minimal or low toxicity.

Another embodiment of the invention is directed to an assembly where a surface altering agent has a soft modulus of elasticity.

Another embodiment of the invention is directed to an assembly where a surface altering agent has a surface energy of less than 35 dynes/cm.

Another embodiment of the invention is directed to an assembly where a surface altering agent has a surface energy of 12 dynes/cm or less.

Another embodiment of the invention is directed to an assembly where a surface altering agent has a surface energy of 11 dynes/cm or less.

Another embodiment of the invention is directed to an assembly where a surface altering agent has a thickness of less than 0.2 microns.

Another embodiment of the invention is directed to an assembly where a surface altering agent has a thickness of less than 0.1 micron.

Another embodiment of the invention is directed to an assembly where at least one of the components is metal.

Another embodiment of the invention is directed to an assembly where at least one of the components are chosen from copper, aluminum, ceramic, steel, tin, glass, and combinations thereof.

Another embodiment of the invention is directed to an assembly where an adhesive is a two part epoxy.

Another embodiment of the invention is directed to an assembly where the two parts of an epoxy are mixed on one component.

Another embodiment of the invention is directed to an assembly where a first part of an epoxy is applied to the first component and a second part of the epoxy is applied to the second component.

Another embodiment of the invention is directed to an assembly where an adhesive is cured with heat.

Another embodiment of the invention is directed to an assembly where an adhesive is applied using at least one of brushing, dripping, pouring and mechanical dispensing.

Another embodiment of the invention is directed to an assembly where the surface altering agent is applied to a portion of one surface of one component.

Another embodiment of the invention is directed to an assembly where at least a part of one surface of one component is free from any surface altering agent.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIGS. 1(a)-(b) are diagrams of a known method of preventing adhesive from migrating during assembly.

FIGS. 2(a)-(b) are diagrams of an embodiment of the present method of preventing adhesive from migrating during assembly.

FIG. 3 depicts experimental results using the present invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

A problem in the art capable of being solved by the embodiments of the present invention is the undesirable spreading of adhesive into sensitive areas during the assembly of apparatuses. Current designs use a grove to trap the adhesive and attempt to prevent the undesired spread of the adhesive or coat an entire component with non-wettable substances. It has been surprisingly discovered that a small, localized surface altering agent, such as an anti-wetting agent, is capable of preventing the spread of adhesive beyond surface to which the agent is applied. By lowering the surface energy of the surface below the surface tension of the adhesive, it is possible to impede the flow of the adhesive.

As embodied and broadly described herein, the present invention is directed to a method of controlling adhesive migration in an assembly. The method includes the steps of applying a surface altering agent to a small part of the surface of at least one component to be coupled, applying adhesive to at least one surface of at least one component, and coupling at least two components together. Another embodiment of the present invention is directed toward an assembly. The assembly includes at least two components coupled together by an adhesive. The assembly further includes a surface altering agent which is applied to at least one component to impede the spread of the adhesive.

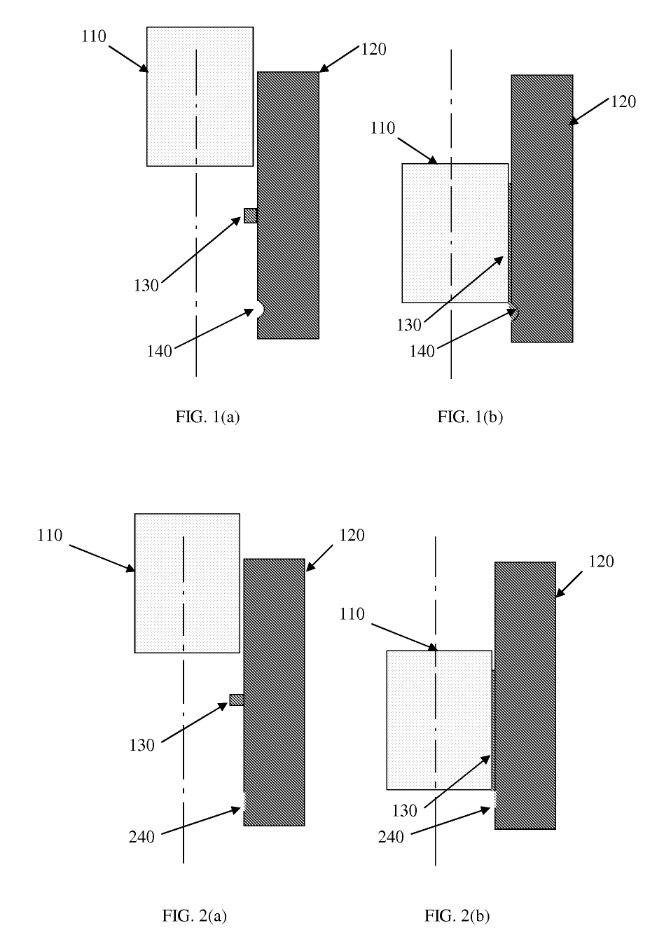

FIGS. 1(a) and 1(b) show diagrams of a known method of preventing an adhesive 130 from spreading beyond the confines of the components to be coupled. As can be seen in FIG. 1(a), a first component 120 has a machine grove 140 cut out. The adhesive 130 is then applied to component 120. Thereafter, as can be seen in FIG. 1(b), a second component 110 is coupled to component 120, thereby spreading out adhesive 130. As adhesive 130 spreads out between components 110 and 120, any excess adhesive is caught by machine grove 140. If too much of adhesive 130 is used or machine grove 140 is not cut deep enough, adhesive 130 may be able to continue to spread beyond machine grove 140 and contaminate sensitive areas before it is cured. Furthermore, after adhesive 130 cures it may be necessary to clean up any excess adhesive 130 that could interfere with the workings of the assembly.

FIGS. 2(a) and 2(b) show diagrams of an embodiment of a method of the present invention. As can be seen in FIG. 2(a), instead of machine grove 140 (seen in FIGS. 1(a)-(b)), component 120 may have a surface altering agent 240. Surface altering agent 240 may be an anti-wetting agent, also known as a barrier film. Surface altering agent 240 may be able to fill capillaries in the surface to which it is applied and prevent the wetting of such surface. Surface altering agent 240 may have a low surface energy and, thereby, may prevent the spread of adhesive 130 beyond the surface area to which surface altering agent 240 is applied. Surface altering agent 240 may have a surface energy below the surface to which it is applied as well as below the surface tension of adhesive 130. Surface altering agent 240 may have a surface energy below 35 dynes/cm, below 20 dynes/cm, below 12 dynes/cm, or below 11 dynes/cm. Surface altering agent 240 may also be able to reduce or impede the spread of other liquids and contaminates.

Surface altering agent 240 may be applied by dipping the component into the agent, spraying the component with the agent, painting the component with the agent, or any other means know. Surface altering agent 240 may be applied in a layer that has a thickness of less than 0.2 microns, less than 0.1 microns, or less than 0.05 microns. Furthermore, surface altering agent 240 may be applied only to a small area of the surface of a component. Surface altering agent 240 may be applied to numerous surfaces of a component. However, surface altering agent 240 shall not coat the entirety of a component. Once surface altering agent 240 is applied, it may need to dry at room temperature. Alternatively, surface altering agent 240 may need to be heated to a temperature above room temperature and that heat may need to be maintained for an extended period of time. In one embodiment, the heat is applied for at least fifteen minutes at 100° C., however any amount of heat may be applied for any period of time. Surface altering agent 240 may also be cured by any other method known.

Surface altering agent 240 may a stable fluorocarbon polymer such as NyeBar® made by Nye Lubricants. Surface altering agent 240 may also be made of fluorochemical acrylate polymer substance, a hydrofluoroether solvent, polyethylene, polytetrafluoroethylne, polyvinylidene chloride, polyvinylidene fluoride, ethylene-vinyl alcohol copolymer, metals, aluminum, silicon oxide, silicon dioxide, ethylene, chlorotrifluoroethylene copolymer, polychlorotrifluoroethylene polymer or any combination thereof. Additionally, surface altering agent 240 may be suspended in a perfluoralkane solvent that easily evaporates.

Surface altering agent 240 may be insoluble in heptane, toluene, water or any combination thereof, yet may be strippable with fluorinated solvents. Surface altering agent 240 may be transparent or have a refractive index of 1.5, 1.0, 0.5 or less. Surface altering agent 240 may have minimal or low toxicity and a soft modulus of elasticity.

As can be seen in FIG. 2(b), when components 110 and 120, which can be comprised of metal, ceramic, or glass, are coupled, adhesive 130 may only spread as far as surface altering agent 240. Surface altering agent 240 acts as a barrier and does not allow adhesive 130 to spread beyond the area to which surface altering agent 240 is applied. Surface altering agent 240 may be applied so that it completely surrounds the area of adhesion or so that it just prevents adhesive 130 to spread in a particular direction, or any combination thereof. Surface altering agent 240 may be applied only to the region of the component necessary to prevent the spread of adhesive 130 into sensitive areas.

In some embodiments, adhesive 130 may be a two part epoxy, like EPO-TEK® 353ND made by AngstromBond®. In such embodiments, the two parts may be mixed on one component before the second component is coupled, or one part may be applied to each component so that the parts mix when the components are coupled. However, any adhesive capable of coupling two components together may be used. For adhesive 130 to cure, heat may need to be applied for an extended period of time. Furthermore, adhesive 130 may be applied by brushing, dripping, poring, mechanical dispensing or any other means known.

The following examples illustrate embodiments of the invention, but should not be viewed as limiting the scope of the invention.

### EXAMPLES

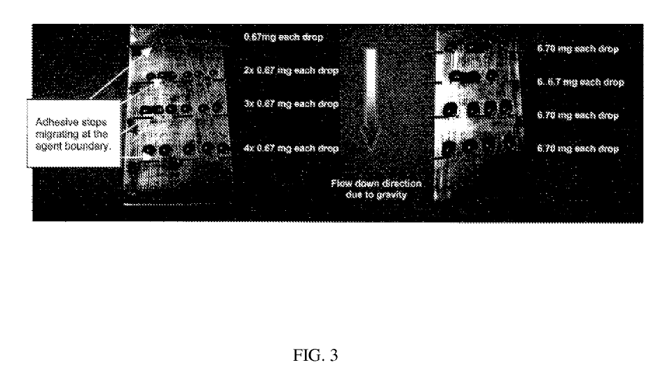

FIG. 3 shows two experiments that were conducted using an embodiment of the present invention. A surface altering agent was applied to two steel plates and allowed to set. Various amounts of adhesive were then applied to each plate. The plates with the adhesive were then arranged so that the adhesive would spread toward the surface altering agent due to gravity. The plates were then placed in an oven and heated until the adhesive cured.

The plate on the left of FIG. 3 was loaded with normal adhesive. The black dotted liens show the location of the surface altering agent. The first row of adhesive consisted of several test sites with one 0.67 mg drop each. The second row consisted of several test sites with two 0.67 mg drops each. The third row consisted of several test sites with three 0.67 mg drops each. The final row consisted of several test sites with four 0.67 mg drops each. In each instance, the adhesive did not penetrate the area where the surface altering agent was applied.

In the second experiment, as can be seen on the right of FIG. 3, the plate was loaded with 600% (6.70 mg) more adhesive than would normally be used in an assembly process. The adhesive on the first two rows was loaded right at the upper boundary of the surface altering agent. On the other hand, the adhesive on the last two rows was loaded at a distance away from the upper boundary of the surface altering agent. In all four instances, the adhesive spread until it met the boundary of the surface altering agent, at which point it stopped.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims.

1. A method of controlling adhesive migration in an assembly, comprising the steps of:
applying an adhesive to at least one surface of a first component;
applying a surface altering agent to at least one surface of at least one of the first component and a second component; and
coupling the second component to the first component.

2. The method of claim 1, wherein the surface altering agent at least one of fills capillaries of the surface area to which it is applied, prevents wetting of the surface area to which it is applied, and prevents the spread of the adhesive beyond the surface area to which it is applied.

3. The method of claim 1, wherein the surface altering agent is applied by at least one of dipping the component into the agent, spraying the component with the agent, and painting the component with the agent.

4. The method of claim 1, further comprising at least one of the steps of allowing the surface altering agent to dry at room temperature before coupling the components, heating the surface altering agent to a temperature of grater than 25° C. before coupling the components, and heating the surface altering agent for at least fifteen minutes.

5. The method of claim 1, wherein the surface altering agent is supplied in perfluoralkane solvents and the perfluorolkane solvent evaporates.

6. The method of claim 1, wherein the surface altering agent comprises at least one of a stable fluorocarbon polymer, fluorochemical acrylate polymer substance, a hydrofluoroether solvent, polyethylene, polytetrafluoroethylne, polyvinylidene chloride, polyvinylidene fluoride, ethylene-vinyl alcohol copolymer, metals, aluminum, silicon oxide, silicon dioxide, ethylene, chlorotrifluoroethylene copolymer, and polychlorotrifluoroethylene polymer.

7. The method of claim 1, wherein the surface altering agent is insoluble in heptane, toluene, water, or combinations thereof and the surface altering agent is strippable with fluorinated solvents.

8. The method of claim 1, wherein at least one of the components are chosen from copper, aluminum, ceramic, steel, tin, glass, and combinations thereof.

9. The method of claim 1, wherein the adhesive is a two part epoxy.

10. The method of claim 1, wherein at least a part of one surface of one component is free from any surface altering agent.

11. An assembly comprising:
a first component;
a second component coupled to the first component;
an adhesive coupling the first component to the second component; and
a surface altering agent to prevent the spread of the adhesive.

12. The assembly of claim 11, wherein the surface altering agent at least one of fills capillaries of the surface area to which it is applied, prevents wetting of the surface area to which it is applied, and prevents the spread of the adhesive beyond the surface area to which it is applied.

13. The assembly of claim 11, wherein at least one of the surface altering agent and the adhesive are both applied to the same surface of the first component and the surface altering agent is applied to a location other than the location to which the adhesive is applied.

14. The assembly of claim 11, wherein the surface altering agent is at least one of dried at room temperature before the components are coupled, heated to a temperature of grater than 25° C. before the components are coupled, and heated for at least fifteen minutes.

15. The assembly of claim 11, wherein the surface altering agent is supplied in perfluoralkane solvents and the perfluoralkane solvent evaporates.

16. The assembly of claim 11, wherein the surface altering agent is comprised of at least one of a stable fluorocarbon polymer, fluorocarbon, fluorochemical acrylate polymer substance, a hydrofluoroether solvent, polyethylene, polytetrafluoroethylne, polyvinylidene chloride, polyvinylidene fluoride, ethylene-vinyl alcohol copolymer, metals, aluminum, silicon oxide, silicon dioxide, ethylene, chlorotrifluoroethylene copolymer, and polychlorotrifluoroethylene polymer.

17. The assembly of claim 11, wherein the surface altering agent is insoluble in heptane, toluene, water, or combinations thereof and strippable with fluorinated solvents.

18. The assembly of claim 11, wherein at least one of the components are chosen from copper, aluminum, ceramic, steel, tin, glass, and combinations thereof.

19. The assembly of claim 11, wherein at least a part of one surface of one component is free from any surface altering agent.

20. A method of controlling adhesive migration in an assembly, comprising the steps of:
applying an adhesive to at least one surface of a first component;
applying a surface altering agent to at least one surface of at least one of the first component and a second component; and
coupling the second component to the first component,
wherein at least a part of one surface of at least one of the first component and the second component is free from any surface altering agent.
